(19) United States
(12) Patent Application Publication
(10) Pub. No.: US 2021/0031344 A1
(43) Pub. Date: Feb. 4, 2021

(54) WHEEL RIM REMOVAL TOOL

(71) Applicant: Robert Edward Sheriff, Spencer, IN (US)

(72) Inventor: Robert Edward Sheriff, Spencer, IN (US)

(21) Appl. No.: 16/944,937

(22) Filed: Jul. 31, 2020

Related U.S. Application Data
(60) Provisional application No. 62/882,211, filed on Aug. 2, 2019.

(51) Int. Cl. B25B 27/02; B60B 29/00

(52) U.S. Cl. CPC B25B 27/023; B60B 29/001

(57) ABSTRACT

A puller device for removing a component from another component, such as a wheel rim or pulley from an axle. The illustrative puller device includes a cross yoke, a pair of couplers that are movable along the yoke, and a forcing screw. The underside of the yoke may include steps or lands that are spaced to assist in centering the yoke into a wheel rim to be removed.

### CROSS REFERENCE TO RELATED APPLICATION

This application claims the benefit of U.S. Provisional Application Ser. No. 62/882,211, filed Aug. 2, 2019, the disclosure of which is expressly incorporated by reference herein.

### BACKGROUND AND SUMMARY OF THE DISCLOSURE

The present invention relates generally to a puller device. More particularly, the present invention relates to a puller device for servicing a component such as a riding mower, lawn tractor or garden tractor component.

Riding mowers, lawn tractors, and garden tractors include components that need to be replaced or serviced after a period of time. Such components include tires and transmissions/transaxles. Also, pulleys occasionally need to be removed to service belts, to remove the engine component from the vehicle during repairs, and/or for replacement. Often these components can be difficult, if not nearly impossible, to remove as rust and/or dirt can become lodged between the hub of the rims and/or pulleys and the respective mounting shaft. In removing the wheel rims, the mechanic often has to heat the rim's hubs with a cutting torch, heating it until the hub is red hot (to make the hub expand), and then beating the hub off with a heavy hammer and a pipe. This method is often time consuming, difficult, changes the temper of the hub metal, and burns the paint off of the rim/hub. Once the rim is removed using this method, the rim must typically be repainted to avoid future rusting. Bare metal that has been heated rusts rather quickly if not treated with paint. To properly paint the metal, the technician has to prep the metal by sanding and other various metal prep procedures.

Another known wheel rim removal method utilizes an automotive steering wheel puller. Obviously, such a puller is not designed with wheel rims in mind. The steering wheel puller may mount to the wheel weight mounting holes in the wheel rim. However, the yoke of the steering wheel puller is typically too short to reach the sides of the rim, necessary when using the two jaw side of the puller. Also, because of its short length, the pulling legs mount at an angle. Pulling legs should always be parallel to the thrust of the pull. Invariably the yoke of the steering wheel puller flops, requiring the operator to reset the assembly. Also, the force applying end of the forcing screw has a bell shaped button at the end of it. This “bell” is too big to fit inside the hub. The bell also has a flat bottom. Since it is too big to fit inside the hub, the mechanic is often forced to insert an extra long bolt into the retaining bolt hole in the axle (if it has a retaining bolt in the end of the axle.). This leads to another frustrating problem. Because the “bell” has a flat surface on the bottom, the forcing screw has a tendency to walk off the extending bolt head. Obviously, when this happens the puller must again be reset. As such, this process can be time consuming and expensive.

Still, another known method of removing wheel rims (and pulleys) utilizes an air impact chisel with a hammering bit to vibrate the rim or pulley off the mounting shaft. Theoretically, placing the air hammering bit on the shaft and vibrating the shaft, breaks up the rust inside the rim or pulley. While vibrating, the mechanic uses a pry bar to apply pressure to the component being removed. This method often fails to work, and can damage the end of the shaft being vibrated.

A current method of removing pulleys is to use a gear puller. This method almost always damages the pulley being pulled, requiring replacement of the pulley.

Thus, current servicing techniques can result in vehicle or component damage, significant time lost, or other undesirable conditions.

Therefore it is desirable to provide a tool that can easily remove the component being serviced by the user in a timely manner with the least damage possible.

The present invention provides an improvement over prior art devices and related methods, wherein in one aspect an apparatus is provided that in some embodiments include a puller that includes an easily adjusted mechanism to quickly mount puller bolts to the component being serviced, a forcing screw that will stay centered over the mounting shaft having pressure applied to, and a yoke configured to remain stable during the pulling operation.

According to an illustrative embodiment of the present disclosure, a wheel rim removal tool includes a self-centering yoke including a body extending between a first end and a second end, the body having a front face, a rear face, a first centering surface and a second centering surface positioned intermediate the front face and the rear face, the first centering surface diametrically opposed to the second centering surface. The first centering surface and the second centering surface are configured to engage with a sidewall of a wheel rim and center the yoke relative to the wheel rim. A threaded opening is centered intermediate the first centering surface and the second centering surface, the threaded opening extending within the body between the front face and the rear face. A first receiving opening and a second receiving opening extend within the body between the front face and the rear face, the first receiving opening positioned intermediate the first end and the threaded opening, and the second receiving opening positioned intermediate the second end and the threaded opening. A forcing screw includes a shaft extending between a proximal end and a distal end, a tool engagement portion supported by the proximal end, an axle engagement portion supported by the distal end, and threads supported on at least a portion of the shaft and received within the threaded opening of the yoke. A first coupler includes a first shaft extending between a proximal end and a distal end, the first shaft extending through the first receiving opening such that the proximal end is positioned proximal of the front face of the yoke, threads supported by the proximal end of the first shaft, a mounting nut engaging the threads of the first shaft, and a first force distributing wing supported by the distal end of the first shaft and configured to engage with a web of the wheel rim. A second coupler includes a second shaft extending between a proximal end and a distal end, the second shaft extending through the second receiving opening such that the proximal end is positioned proximal of the front face of the yoke, threads supported by the proximal end of the second shaft, a mounting nut engaging the threads of the second shaft, and a second force distributing wing supported by the distal end of the second shaft and configured to engage with the web of the wheel rim.

According to another illustrative embodiment of the present disclosure, a wheel rim removal tool includes a yoke including a body extending between a first end and a second end, the body having a front face, a rear face, and a threaded opening centered intermediate the first end and the second end, the threaded opening extending within the body between the front face and the rear face. A first receiving opening and a second receiving opening extend within the body between the front face and the rear face, the first receiving opening positioned intermediate the first end and the threaded opening, and the second receiving opening positioned intermediate the second end and the threaded opening. A forcing screw includes a shaft extending between a proximal end and a distal end, a tool engagement portion supported by the proximal end, an axle engagement portion supported by the distal end, and threads supported on at least a portion of the shaft and received within the threaded opening of the yoke. A first coupler includes a first shaft extending between a proximal end and a distal end, the first shaft extending through the first receiving opening such that the proximal end is positioned proximal of the front face of the yoke, threads supported by the proximal end of the first shaft, a mounting nut engaging the threads of the first shaft, and a first force distributing wing supported by the distal end of the first shaft and configured to engage with a web of the wheel rim. A second coupler includes a second shaft extending between a proximal end and a distal end, the second shaft extending through the second receiving opening such that the proximal end is positioned proximal of the front face of the yoke, threads supported by the proximal end of the second shaft, a mounting nut engaging the threads of the second shaft, and a second force distributing wing supported by the distal end of the second shaft and configured to engage with the web of the wheel rim. Each of the first receiving opening and the second receiving opening of the yoke includes a laterally extending slot, thereby facilitating alignment of the first coupler and the second coupler with openings in the web of the wheel rim.

According to a further illustrative embodiment of the present disclosure, a puller device includes a yoke including a body extending between a first end and a second end, the body having a front face, a rear face, and a threaded opening centered intermediate the first end and the second end, the threaded opening extending within the body between the front face and the rear face. A first receiving slot and a second receiving slot extend within the body between the front face and the rear face, the first receiving slot positioned intermediate the first end and the threaded opening, and the second receiving slot positioned intermediate the second end and the threaded opening. A forcing screw includes a shaft extending between a proximal end and a distal end, a tool engagement portion supported by the proximal end, an axle engagement portion supported by the distal end, and threads supported on at least a portion of the shaft and received within the threaded opening of the yoke. A first coupler and a second coupler are supported by the yoke, each of the first coupler and the second coupler including a base, a pedestal extending above the base, a clamping head supported by the pedestal, and a mounting shaft extending below the base. The mounting shaft of the first coupler is supported within the first receiving slot of the yoke for sliding movement therewithin, and the mounting shaft of the second coupler is supported within the second receiving slot of the yoke for sliding movement therewithin.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative pulling device of the present disclosure in the form of a wheel rim removal tool, showing an illustrative wheel rim in cross-section;

FIG. 2 is a cross-sectional view of the illustrative wheel rim removal tool and wheel rim of FIG. 1;

FIG. 3 is a perspective view of the illustrative wheel rim removal tool of FIG. 1;

FIG. 4 is an exploded perspective view of the illustrative wheel rim removal tool of FIG. 1;

FIG. 5 is a side elevational view of an illustrative yoke of the wheel rim removal tool of FIG. 1;

FIG. 6 is a bottom plan view of the illustrative yoke of FIG. 5;

FIG. 7 is a side elevational view of a further illustrative pulling device in the form of a pulley removal tool, showing an illustrative pulley in cross-section;

FIG. 8 is a rear elevational view of an illustrative pulley coupler of the pulley removal tool of FIG. 7;

FIG. 9 is a front elevational view of the illustrative pulley coupler of FIG. 8;

FIG. 10 is a side elevational view of the illustrative pulley coupler of FIG. 8;

FIG. 11 is a top plan view of the illustrative pulley coupler of FIG. 8; and

FIG. 12 is a side elevational view of a further illustrative embodiment yoke for use with the illustrative pulling device of FIG. 1.

### DETAILED DESCRIPTION OF THE DRAWINGS

For the purposes of promoting and understanding the principles of the present disclosure, reference will now be made to the embodiments illustrated in the drawings, which are described herein.

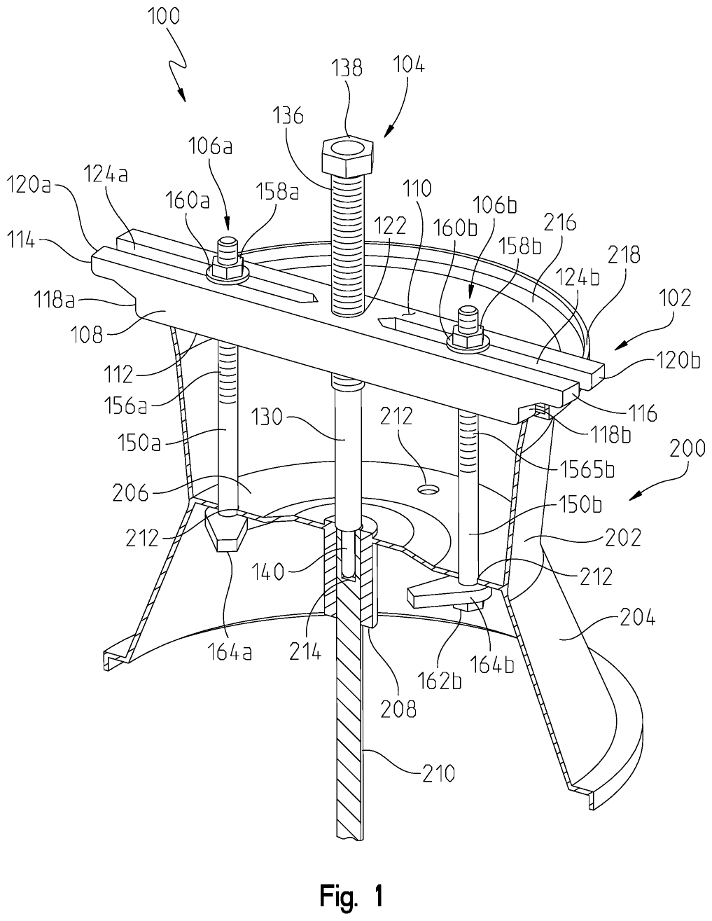

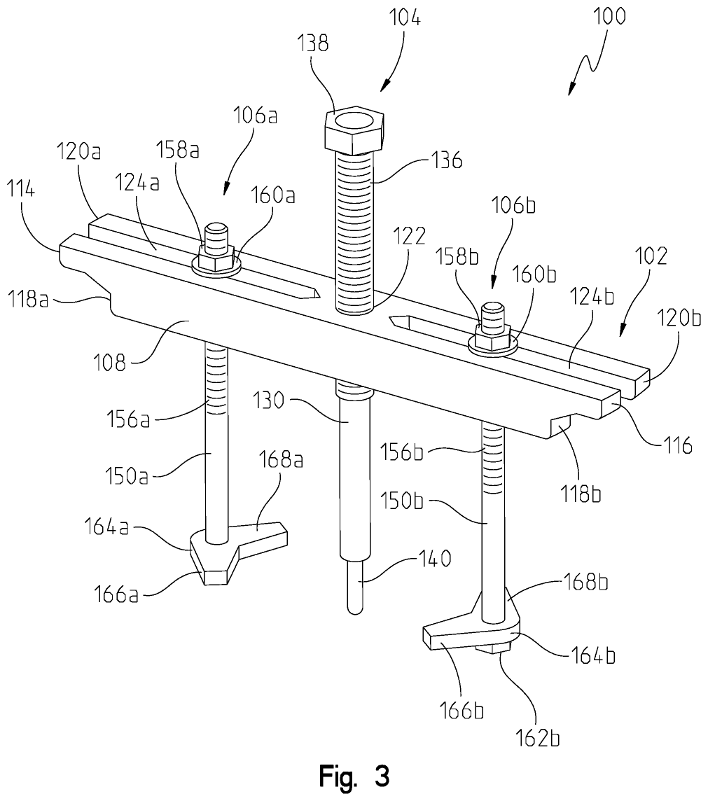

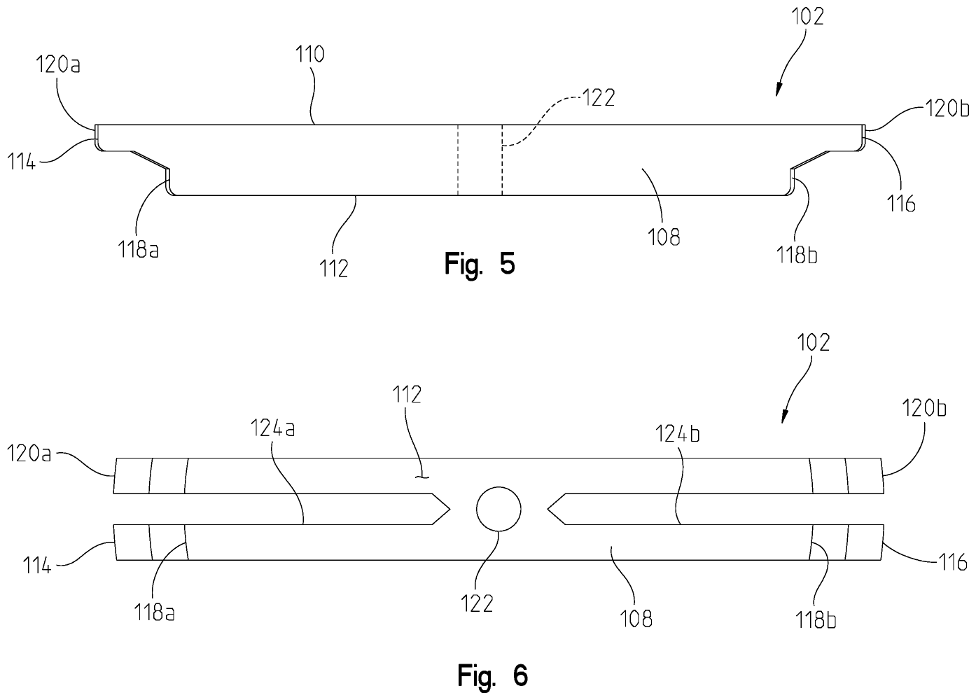

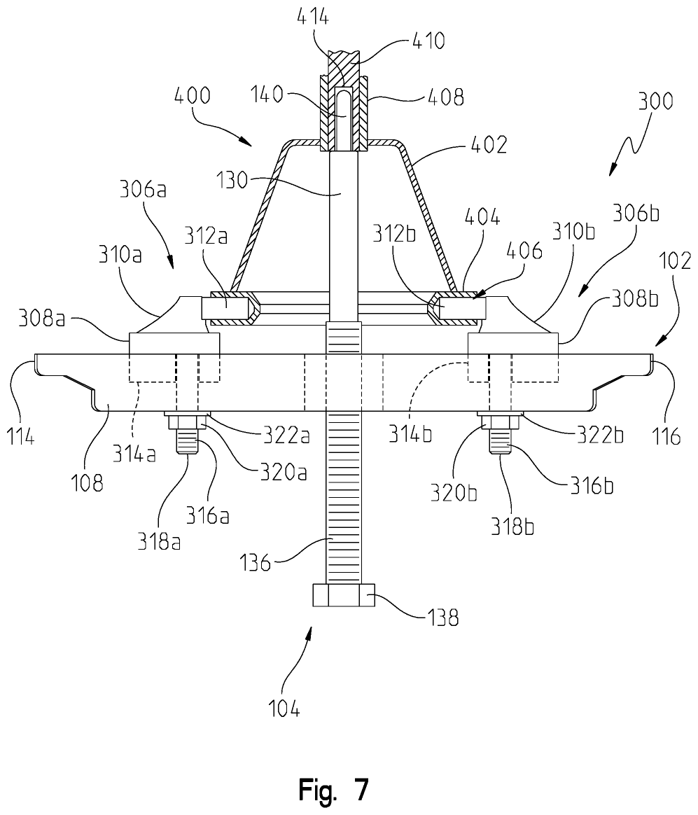

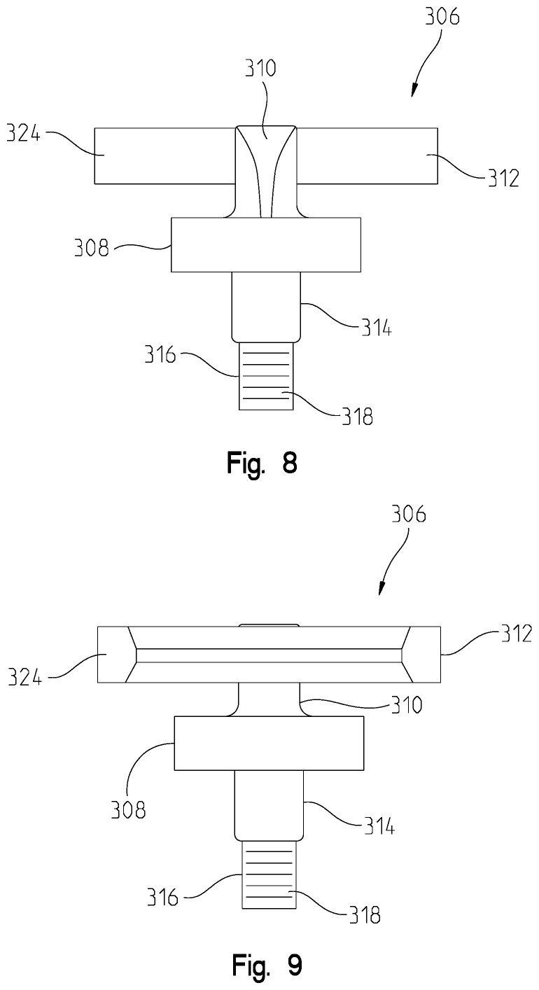

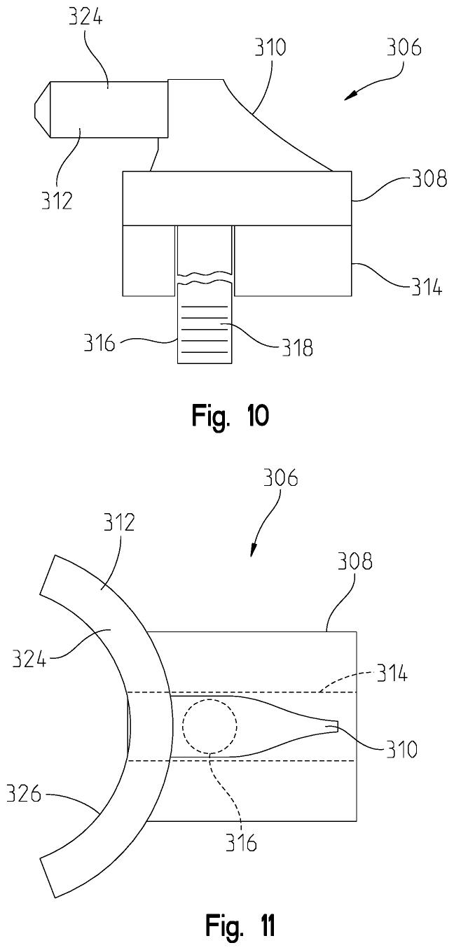

The puller device of the present disclosure includes different illustrative embodiments, including a wheel rim removal tool 100 for removing a wheel rim 200 (FIGS. 1-6), and a pulley removal tool 300 for removing a pulley 400 (FIGS. 7-12).

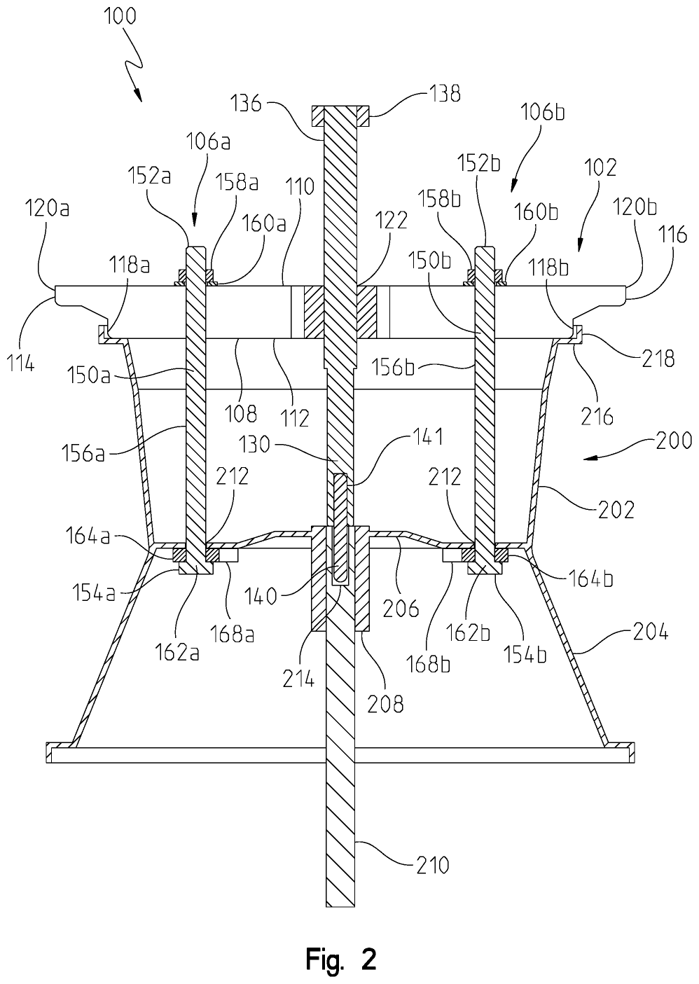

With reference to FIGS. 1 and 2, the illustrative wheel rim removal tool 100 is designed specifically to separate the rear wheel rim 200 from a rear axle or mounting shaft 210 of a vehicle, such as a riding mower. The wheel rim 200 is illustratively of conventional design as including an outer portion 202 and an inner portion 204. A laterally extending web 206 illustratively extends radially inwardly from a position proximate the interface between the outer portion 202 and the inner portion 204 of the wheel rim 200. A center coupler or hub 208 may secure the web 206 to the mounting shaft 210. A plurality of circumferentially spaced openings or holes 212 are formed within the web 206 and are configured to receive balancing weights (not shown). A center recess or bore 214, such as a retaining bolt hole, may be formed within a proximal end of the axle 210. The outer portion 202 of the wheel rim 200 includes a radially outwardly extending lip 216 and an axially outwardly extending flange or sidewall 218. Both the lip 216 and the flange 218 are illustratively cylindrical.

As shown in FIGS. 1 and 4-6, the illustrative embodiment wheel rim removal tool 100 includes a yoke or stabilizing bar 102, a forcing screw 104 cooperating with the yoke 102, and first and second couplers or pulling legs (e.g., bolts) 106a and 106b extending between the yoke 102 and the connecting portion 206 of the wheel rim 200. The yoke 102 illustratively includes a body 108 illustratively formed of tool steel or cast iron. The body 108 includes a front (proximal) or upper face 110 and a rear (distal) or lower face 112, and extends between opposing first and second ends 114 and 116.

The yoke 102 includes centering surfaces or lands to assist in centering the yoke 102 on the rim 200. Centering is important to an efficient pulling operation, as it requires pulling in a perpendicular motion. A first centering surface, step or land 118a and a second centering surface, step or land 118b face outwardly and are configured to engage with the with the flange 218 of the rim 200, and thereby center the yoke 102 relative to the wheel rim 200. Illustratively, the first and second centering surfaces 118a and 118b are spaced apart by approximately 7.8 inches to receive an 8 inch diameter wheel rim 200. A third centering surface, step or land 120a and a fourth centering surface, step or land 120b face outwardly and are configured to engage with a wheel rim 200 having a different rim diameter. More particularly, the third and fourth centering surfaces 120a and 120b are spaced apart by approximately 9.8 inches to receive a 10 inch diameter wheel rim 200.

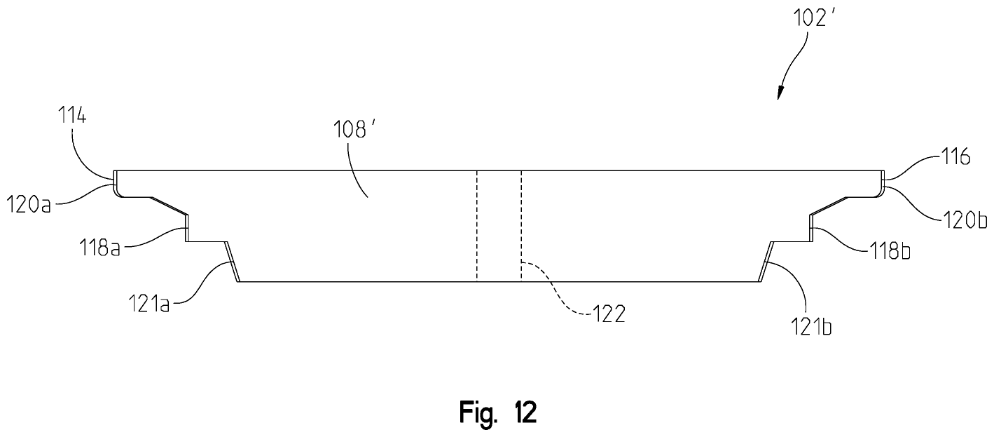

A further illustrative embodiment yoke 102′ is shown in FIG. 12 for use with the wheel rim removal tool 100. The illustrative yoke 102′ includes a body 108′ having additional centering surfaces, steps or lands, such as a fifth centering surface or land 121a and a sixth centering surface or land 121b configured to engage with a wheel rim 200 having a different rim diameter than that configured for use with the first and second centering surfaces 118a and 118b, and the third and fourth centering surfaces 120a and 120b. It should be appreciated that the number of, and spacing between, centering surfaces or lands may vary depending, for example, upon the number, and diameters of, the different wheel rims configured for use with the respective yoke 102′.

A threaded opening 122 illustratively extends within the body 108 of the yoke 102 in the center thereof to allow the forcing screw 104 to received therein. A first receiving opening 124a and a second receiving opening 124b extend within the body 108 between the front face 110 and the rear face 112. The first receiving opening 124a is positioned intermediate the first end 114 (e.g., the first centering surface 118a) and the threaded opening 122, and the second receiving opening 124b is positioned intermediate the second end 116 (e.g., the second centering surface 118b) and the threaded opening 122. The first and second receiving openings 124a and 124b illustratively comprise laterally extending slots, thereby allowing for the adjustment of the pulling legs 106a and 106b therewithin.

The forcing screw 104 illustratively includes a shaft 130 formed of a hardened tempered steel, extending longitudinally between a proximal end 132 and a distal end 134. External threads 136 extend along at least a portion of the shaft 130 and are received within the threaded opening 122 of the yoke 102. A tool engagement portion is illustratively fixed to the proximal end 132 of the shaft 130. In one illustrative embodiment, the tool engagement portion comprises a hex nut 138 welded to the proximal end 132 of the shaft 130.

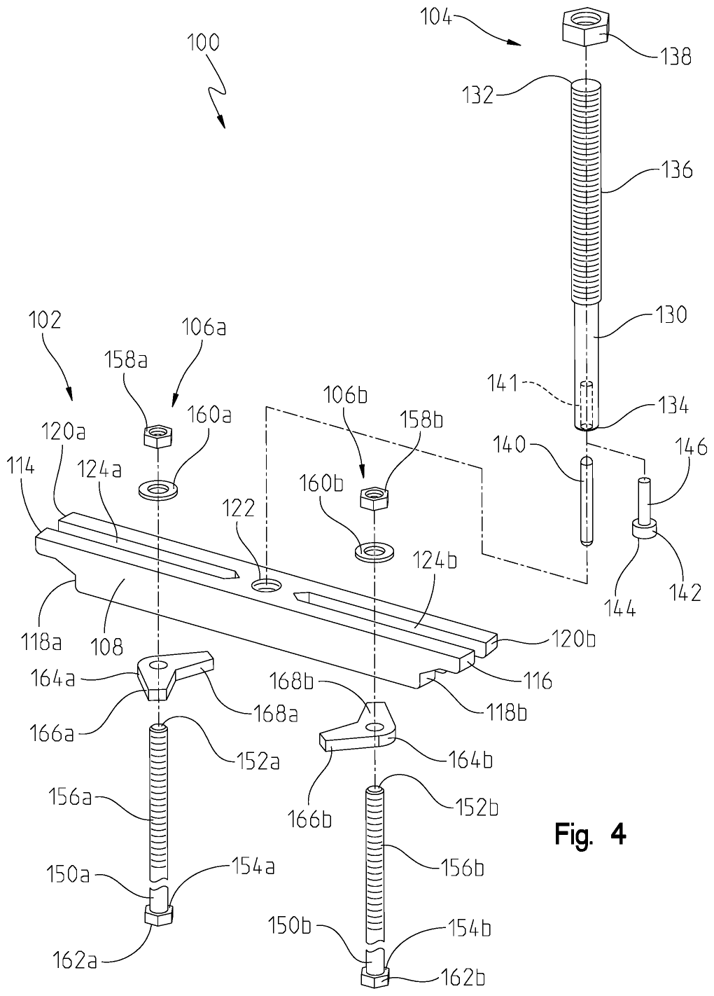

An axle engagement portion is illustratively supported by the distal end 134 of the shaft 130. In one illustrative embodiment, the axle engagement portion comprises a pin 140 received within a receiving bore 141 at the distal end 134 of the shaft 130. The pin 140 is received within the center bore 214 of the axle 210 to center the shaft 130 on the axle 210. The pin 140 is illustratively of a certain length, designed to reach the bottom of the center bore 214 in the axle 210. The pin 140 would also help keep the forcing screw 104 centered over the axle 210 having force applied to it. With reference to the alternative embodiment of FIG. 4, the axle engagement portion may alternatively comprise a button 142 including a flat head 144 supported by a shaft 146. The shaft 146 is received within the receiving bore 141 of the shaft 130, and the flat head 144 is configured to engage with the end of an axle 210 not including a center bore 214. The button 142 would act as a friction plate against the forcing screw 104 and the axle 210. The need for a button 142 is demonstrated by solid axles that do not have a retaining bolt hole 214.

The first and second pulling legs 106a and 106b illustratively include first and second shafts 150a and 150b, respectively. Each shaft 150a and 150b extends between a proximal end 152a, 152b and a distal end 154a, 154b. External threads 156a, 156b extend along at least a portion of each shaft 150a, 150b, illustratively at the proximal end 152a, 152b. The pulling legs 106a and 106b are illustratively long enough to reach from the backside of the rim 200 to extend from the top of the yoke 102. More particularly, the shafts 150a, 150b extend through the openings 124a, 124b such that the proximal ends 152a, 152b are supported proximal of the front face 110 of the yoke 102. Mounting nuts 158a, 158b and force distributing washers 160a, 160b engage with the threads 156a, 156b proximal of the front face 110 of the yoke 102. A stop, illustratively a hex head 162a, 162b, is fixed to the distal end 154a, 154b of each shaft 150a, 150b. A force distributing member or wing 164a, 164b is supported by the head 162a, 162b and is configured to engage a lower or distal surface of the rim web 206.

Each force distributing wing 164a, 164b includes extensions 166a, 166b and 168a, 168b to help distribute force. The force distributing wings 164a, 164b are illustratively shaped in a “V” or winged shape to distribute force over an area of the rim web 206. Normal washers typically cannot fit, flatly, into the backside of the rim 200 when aligned with the wheel weight mounting holes 212. The force distributing wings 164a, 164b each have an offset hole proximate the middle, with the offset being towards the outside of the wing 164a, 164b. The wings 164a, 164b are rigid to prevent bending during pulls. The wings 164a, 164b are configured to prevent the heads 162a, 162b of the pulling legs 106a, 106b from being pulled through the openings 212 in the rim 200.

The smooth upper face 110 and the first and second slots 124a and 124b of the yoke 102 allow the pulling legs 106a, 106b to be received in whatever position needed to perform the wheel rim removal operation, with centering surfaces or lands 118a, 118b, 120a, 120b at a certain predetermined distances from each other (as detailed above, the illustrative yoke 102 may be sized to fit 8″ and 10″ rims, but could be sized to fit other size rims). Extending distally through, and aligning the yoke 102 centered with the wheel rim 200 to be serviced, are the pair of pulling legs 106a, 106b. Rotational force or torque applied to the hex nut 138 of the forcing screw 104 equates to linear force axially driving the yoke 102 away from the wheel rim 200. The pulling legs 106a, 106b apply axial force from the yoke 102 toward the web 206, thereby pulling the wheel rim 200 outwardly (proximally) along the longitudinal axis of the axle 210.

With reference to FIG. 7, the illustrative pulley removal tool 300 is designed specifically to separate the pulley 400 from an axle or mounting shaft 410. The pulley 400 is illustratively of conventional design as including a hub or housing 402 including an annular rim 404 defining a groove 406 of the type configured to receive a belt (not shown). A center coupler 408 secures the housing 402 to the mounting shaft 410.

The illustrative embodiment pulley removal tool 300 includes many similar components as the illustrative wheel rim removal tool 100 detailed above. As such, in the following description similar components are identified with like reference numbers. More particularly, the pulley removal tool 300 includes the yoke 102 and the forcing screw 104 detailed above.

Referring now to FIGS. 7-11, first and second pulley couplers 306a and 306b are illustratively supported by the yoke 102. More particularly, the pulley couplers 306a and 306b are supported within the receiving slots 124a and 124b for sliding movement therewithin. Each of the pulley couplers 306a, 306b includes a base 308 and a pedestal 310 extending above the base 308. A clamping head 312 is supported by the pedestal 310. A guide member or tongue 314 extends below the base 308 and is slidably received within the respective slot 124a, 124b. A mounting shaft 316, including external threads 318, extends below the guide member 314. A mounting nut 320a, 320b and a cooperating force distributing washer 322a, 322b engage with the threads 318 of the mounting shaft 316 to secure the pulley coupler 306a, 306b to the yoke 102.

The clamping head 312 is designed to fit inside the groove 406 of the pulley 400 being pulled. The clamping head 312 is designed to reduce or negate any damage to the pulley 400 being pulled. The clamping head 312 includes a body 324 including an inwardly facing arcuate surface 326 that can be of various radii to match the size of the pulley 400 being pulled. The distance the pedestal 310 traverses may also be variable, according to which type of pulley 400 is being pulled.

In accordance with yet another embodiment of the present disclosure, a method of removing a component with the wheel rim removal tool 100 is provided and can include positioning pulling legs 106a, 106b through the wheel weight mounting holes 212 into the yoke 102 and securing them with fasteners 158a, 158b and 160a, 160b to the yoke 102 so that the legs 106a, 106b and the yoke 102 are coupled with the component being serviced, then turning the forcing screw 104 in a first direction with a rotational tool (e.g., wrench) until it contacts the component being serviced, and turning the forcing screw 104 in the first direction to move the component being serviced.

More particularly, illustrative usage instructions of the illustrative wheel rim removal tool 100 include: (1) If the wheel rim 200 to be pulled has a retaining bolt in the end of the axle 210, remove it first. If the axle 210 is solid and has an “E” clip as a retainer, remove that clip first; (2) Insert first pulling leg 106a into the opening in the force distributing wing 164a; (3) Repeat for the other pulling leg 106b and force distributing wing 164b; (4) Insert each pulling leg 106a, 106b through each respective wheel weight mounting holes 212, from the backside of the rim 200; (5) Make sure that the wings 164a, 164b point inwardly towards the hub side of the rim 200 so that they sit flat against the rim 200; (6) From the front side of the rim 200, place yoke 102 against the rim 200 making sure it sits on the appropriate lands 118a, 118b; (7) While the yoke 102 is against the rim 200, reach under the yoke 102 and grab the first pulling leg 106a and feed it through the yoke slot 124a above the corresponding mounting hole 212; (8) While holding the pulling leg 106a in yoke 102, attach fastening nut 158a and washer 160a to the shaft 150a, and tighten to finger tight; (9) Repeat steps 7 and 8 for the second pulling leg 106b, fastening nut 158b and washer 160b; (10) Insert the appropriate pin 140 or button 142 into forcing screw 104. Use pin 140 if the axle 210 has a retaining bolt in the end of it. Use the button 142 if the axle 210 is solid; (11) Rotate the forcing screw 104 until it comes in full contact with the axle 210; (12) Double check that the force distributing wings 164a and 164b are, indeed, sitting flat against the rim 200; (13) Grab the pulling legs 106a and 106b from the front and tighten the fasteners 158a and 158b until snug. Torqueing not required; (14) Apply rotational force, with a ratchet wrench and socket, to the forcing screw 104 until the rim 200 has moved sufficiently to pull the rim 200 off by hand without use of the tool; and (15) If the rim 200 has reached the threads on the forcing screw 104 and is still stuck, back off forcing screw 104 until there is enough space to fit a ⅜″ drive socket into the rim 200. Then resume applying pressure to the forcing screw 104.

In accordance with another illustrative embodiment of the present invention, a method of removing pulley 400 is disclosed via the illustrative pulley removal tool 300 including pulley couplers 306a, 306b having base 308 to support clamping head 312 that mate with the pulley 400. These pulley couplers 306a, 306b, before securing tightly, slide relative to the yoke 102. The yoke 102 is positioned roughly centered over the pulley 400 being serviced, the forcing screw 104 rotated in a first direction into the yoke 102 until it touches the component shaft 410, then the pulley couplers 306a, 306b are adjusted and tightened securely to the pulley 400 and the yoke 102. The forcing screw 104 is then rotated using a rotational tool until the pulley 400 is adequately moved off its shaft 410 for removal.

More particularly, illustrative usage instructions of the illustrative pulley removal tool 300 include: (1) Insert forcing screw 104 into the yoke 102, but only partially, from the underside; (2) Set pulley couplers 306a, 306b on the topside of the yoke 102, with the “C” shaped clamping heads 312 facing towards each other; (3) Attach the fastening nuts 320a, 320b to the bolts 316a, 316b protruding from the yoke 102. But do not tighten all the way. They will need to be moved into final position later; (4) Position yoke 102 into position so that the forcing screw 104 is in line with the pulley's mounting shaft 410; (5) With the forcing screw 104 in position, move the pulley couplers 306a, 306b towards the pulley 400, seating the “C” clamp heads 312 fully into the track of the pulley 400 to be pulled; (6) Tighten the fastening nuts 320a, 320b. By this time, you should be able to let go of the tool 300 and the forcing screw 104 should be lined up with the mounting shaft 410 of the pulley 400; (7) Apply rotational force to the forcing screw 104 until it fully contacts the shaft 410, if doesn't already contact it; (8) Apply rotational force to the forcing screw 104 using a rotational tool (ratchet and socket) until the pulley 400 has moved far enough to be removed from the shaft 410 by hand pulling; and (9) Again, as in above, if the pulley 400 remains stubbornly attached to its shaft 410, you can back off the forcing screw 104 until you acquire enough room to insert a ⅜″ drive socket between the forcing screw 104 and the shaft 410. Then resume the forcing operation.

Although the invention has been described in detail with reference to certain preferred embodiments, variations and modifications exist within the spirit and scope of the invention as described and defined in the following claims.

1. A wheel rim removal tool comprising:
a self-centering yoke including a body extending between a first end and a second end, the body having a front face, a rear face, a first centering surface and a second centering surface positioned intermediate the front face and the rear face, the first centering surface diametrically opposed to the second centering surface, the first centering surface and the second centering surface configured to engage with a sidewall of a wheel rim and center the yoke relative to the wheel rim, a threaded opening centered intermediate the first centering surface and the second centering surface, the threaded opening extending within the body between the front face and the rear face, a first receiving opening and a second receiving opening extending within the body between the front face and the rear face, the first receiving opening positioned intermediate the first end and the threaded opening, and the second receiving opening positioned intermediate the second end and the threaded opening;
a forcing screw including a shaft extending between a proximal end and a distal end, a tool engagement portion supported by the proximal end, an axle engagement portion supported by the distal end, and threads supported on at least a portion of the shaft and received within the threaded opening of the yoke;
a first coupler including a first shaft extending between a proximal end and a distal end, the first shaft extending through the first receiving opening such that the proximal end is positioned proximal of the front face of the yoke, threads supported by the proximal end of the first shaft, a mounting nut engaging the threads of the first shaft, and a first force distributing wing supported by the distal end of the first shaft and configured to engage with a web of the wheel rim; and
a second coupler including a second shaft extending between a proximal end and a distal end, the second shaft extending through the second receiving opening such that the proximal end is positioned proximal of the front face of the yoke, threads supported by the proximal end of the second shaft, a mounting nut engaging the threads of the second shaft, and a second force distributing wing supported by the distal end of the second shaft and configured to engage with the web of the wheel rim.

2. The wheel rim removal tool of claim 1, wherein each of the first receiving opening and the second receiving opening of the yoke comprises a laterally extending slot, thereby facilitating alignment of the first coupler and the second coupler with openings in the web of the wheel rim.

3. The wheel rim removal tool of claim 1, wherein the yoke further includes a third centering surface and a fourth centering surface positioned intermediate the front face and the rear face, the third centering surface diametrically opposed to the fourth centering surface, the third centering surface laterally spaced from the first centering surface intermediate the threaded opening and the first end of the yoke, the fourth centering surface laterally spaced from the second centering surface intermediate the threaded opening and the second end of the yoke, the third centering surface and the fourth centering surface configured to engage with a wheel rim and center the yoke relative to the wheel rim.

4. The wheel rim removal tool of claim 3, wherein the first centering surface and the second centering surface are spaced apart to center a wheel rim having an 8 inch rim diameter, and the third and fourth centering surfaces are spaced apart to center a wheel rim having a 10 inch rim diameter.

5. The wheel rim removal tool of claim 1, wherein the axle engagement portion comprises a centering pin supported by the distal end of the forcing screw, the centering pin having an outer diameter less than an outer diameter of the shaft of the forcing screw.

6. The wheel rim removal tool of claim 5, wherein the centering pin is removably coupled to the distal end of the forcing screw.

7. The wheel rim removal tool of claim 1, wherein the axle engagement portion comprises a button removably coupled to the distal end of the forcing screw.

8. The wheel rim removal tool of claim 1, wherein:
the first shaft of the first coupler includes threads supported at the proximal end, and a nut threadably received by the threads to secure the first coupler within the first receiving opening of the yoke; and
the second shaft of the second coupler includes threads supported at the proximal end, and a nut threadably received by the threads to secure the second coupler within the second receiving opening of the yoke.

9. A wheel rim removal tool comprising:
a yoke including a body extending between a first end and a second end, the body having a front face, a rear face, a threaded opening centered intermediate the first end and the second end, the threaded opening extending within the body between the front face and the rear face, a first receiving opening and a second receiving opening extending within the body between the front face and the rear face, the first receiving opening positioned intermediate the first end and the threaded opening, and the second receiving opening positioned intermediate the second end and the threaded opening;
a forcing screw including a shaft extending between a proximal end and a distal end, a tool engagement portion supported by the proximal end, an axle engagement portion supported by the distal end, and threads supported on at least a portion of the shaft and received within the threaded opening of the yoke;
a first coupler including a first shaft extending between a proximal end and a distal end, the first shaft extending through the first receiving opening such that the proximal end is positioned proximal of the front face of the yoke, threads supported by the proximal end of the first shaft, a mounting nut engaging the threads of the first shaft, and a first force distributing wing supported by the distal end of the first shaft and configured to engage with a web of the wheel rim;
a second coupler including a second shaft extending between a proximal end and a distal end, the second shaft extending through the second receiving opening such that the proximal end is positioned proximal of the front face of the yoke, threads supported by the proximal end of the second shaft, a mounting nut engaging the threads of the second shaft, and a second force distributing wing supported by the distal end of the second shaft and configured to engage with the web of the wheel rim; and
wherein each of the first receiving opening and the second receiving opening of the yoke comprises a laterally extending slot, thereby facilitating alignment of the first coupler and the second coupler with openings in the web of the wheel rim.

10. The wheel rim removal tool of claim 9, wherein the yoke further includes a first centering surface and a second centering surface extending intermediate the front face and the rear face, the first centering surface diametrically opposed to the second centering surface, the first centering surface and the second centering surface configured to engage with a wheel rim and center the yoke relative to the wheel rim.

11. The wheel rim removal tool of claim 9, wherein the yoke further includes a third centering surface and a fourth centering surface positioned intermediate the front face and the rear face, the third centering surface diametrically opposed to the fourth centering surface, the third centering surface laterally spaced from the first centering surface intermediate the threaded opening and the first end of the yoke, the fourth centering surface laterally spaced from the second centering surface intermediate the threaded opening and the second end of the yoke, the third centering surface and the fourth centering surface configured to engage with a wheel rim and center the yoke relative to the wheel rim.

12. The wheel rim removal tool of claim 11, wherein the first centering surface and the second centering surface are spaced apart to center a wheel rim having an 8 inch rim diameter, and the third and fourth centering surfaces are spaced apart to center a wheel rim having a 10 inch rim diameter.

13. The wheel rim removal tool of claim 9, wherein the axle engagement portion comprises a centering pin supported by the distal end of the forcing screw, the centering pin having an outer diameter less than an outer diameter of the shaft of the forcing screw.

14. The wheel rim removal tool of claim 13, wherein the centering pin is removably coupled to the distal end of the forcing screw.

15. The wheel rim removal tool of claim 9, wherein the axle engagement portion comprises a button removably coupled to the distal end of the forcing screw.

16. A puller device comprising:
a yoke including a body extending between a first end and a second end, the body having a front face, a rear face, a threaded opening centered intermediate the first end and the second end, the threaded opening extending within the body between the front face and the rear face, a first receiving slot and a second receiving slot extending within the body between the front face and the rear face, the first receiving slot positioned intermediate the first end and the threaded opening, and the second receiving slot positioned intermediate the second end and the threaded opening;
a forcing screw including a shaft extending between a proximal end and a distal end, a tool engagement portion supported by the proximal end, an axle engagement portion supported by the distal end, and threads supported on at least a portion of the shaft and received within the threaded opening of the yoke;
a first coupler and a second coupler supported by the yoke, each of the first coupler and the second coupler including a base, a pedestal extending above the base, a clamping head supported by the pedestal, and a mounting shaft extending below the base; and
wherein the mounting shaft of the first coupler is supported within the first receiving slot of the yoke for sliding movement therewithin, and the mounting shaft of the second coupler is supported within the second receiving slot of the yoke for sliding movement therewithin.

17. The puller device of claim 16, wherein each of the mounting shaft of the first coupler and the second coupler includes threads, and a mounting nut engaging the threads.

18. The puller device of claim 16, wherein the clamping head of each of the first coupler and the second coupler includes an arcuate body having a radius of curvature configured to conform to a groove of a pulley.

19. The puller device of claim 16, wherein the axle engagement portion comprises at least one of a centering pin and a button removably supported by the distal end of the forcing screw.
